(19) United States
(12) Patent Application Publication
(10) Pub. No.: US 2008/0098113 A1
(43) Pub. Date: Apr. 24, 2008

(54) Stateful firewall clustering for processing-intensive network applications

(76) Inventors: Gert Hansen, Karlsruhe (DE); Patrick McHardy, Freiburg (DE); Ulrich Weber, Rechberghausen (DE); Stephan Scholz, Woschbach (DE)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/584,477

(22) Filed: Oct. 19, 2006

(51) Int. Cl. G06F 15/173; H04L 12/56

(52) U.S. Cl. 709/226; 370/389; 709/223

(57) ABSTRACT

A system and method for balancing network traffic that includes a master node addressable by an external device, at least one slave node addressable by the master node, at least one filter running on the master node and the at least one slave node, and a clusterware application running on the master node and the at least one slave node. The clusterware application distributes the network traffic between the master node and the at least one slave node. Techniques for using the same are also disclosed.

### BACKGROUND

The present invention relates to the field of digital communications, clustering and high availability.

The evolution over the past 20 years of digital communications technology has resulted in the current distributed client-server data networks. In these distributed client-server networks, multiple clients are able to access and share data stored on servers located at various points or nodes through a given network. In the case of the Internet, a client computer is able to access data stored on a server located at any point on the planet, as long as the server is also connected to the Internet.

With the rapid proliferation in use of distributed data networks, such as the Internet, more and more clients from around the world are attempting to connect to and extract data stored on a finite number of servers. Those establishing and maintaining the servers containing the desired data, such as web pages from popular web sites, are finding it difficult to insure that all the clients attempting to access data will be able to do so.

One way to insure that the network servers will have enough resources to process all connection requests is to deploy multiple mirrored servers in conjunction with a load balancer. The mirrored servers are typically connected to the same network and are referred to as a server cluster. When a client attempts to connect to and access data from a server cluster, the client's request is first received by the load balancer which determines which of the servers is best suited to handle the client's request.

There are several known clustering technologies. For example, one clustering technology is referred to as a “stateless failure recovery” clustering. In this type of clustering, in case of a hardware failure, a standby system takes over the tasks of the active failed system. For example, a simple master-slave system with a short failover time (hot standby) would fulfill this requirement. Unfortunately, such a system may not be able to recover the previously established connections after a failover.

Another type of clustering is referred to as a “stateful failure recovery.” In this type of clustering, in case of a system failure, the existing packet or filter connections are not lost. Unfortunately, the stateful failure recovery system requires the cluster applications to be written in a specific way, commonly referred to as “HA-aware.” Furthermore, the effort of re-writing applications to support HA is quite high.

The major drawback of the existing load balancing solutions is that they all require additional hardware, such as load balancers. Additional hardware introduces a set of complications related to performance, synchronization and network address translation.

Accordingly, there is a need to provide a stateful clustering technology that can balance network traffic between multiple servers without the help of a dedicated load balancer.

### SUMMARY

In accordance with implementations of the invention, one or more of the following capabilities may be provided. The present invention provides a method and apparatus for a stateful clustering technology that, in some embodiments, can balance network traffic between multiple servers without the help of a dedicated load balancer. The present invention can preserve the state of the balanced network packets by transmitting the packet state information with each network packet.

These and other capabilities of the invention, along with the invention itself, will be more fully understood after a review of the following figures, detailed description, and claims.

Some embodiments hereof provide a method for balancing network traffic, including the steps of receiving data packets at a master node, applying a set of conditions to determine one or more slave nodes for processing the data packets, forwarding the data packets and a filter state information to the determined slave nodes for processing, receiving the processed data packets and the filter state information from the slave nodes; and outputting the data packets from the master node.

Other embodiments are directed to a system for balancing network traffic including a master node addressable by an external device, at least one slave node addressable by the master node, at least one filter running on the master node and the at least one slave node, a clusterware application running on the master node and the at least one slave node, wherein the clusterware application is configured to distribute the network traffic between the master node and the at least one slave node. In some embodiments, the clusterware application running on the master node monitors and maintains a list of slave nodes. In some embodiments, the list of slave nodes is maintained in RAM. In yet other embodiments, the list of slave nodes is saved on the disk storage. In still other embodiments, the list of slave nodes is saved in the database file.

According to some embodiments, in case of the master node's failure, the clusterware application running on the slave nodes selects a new master. In other embodiments, the new master is selected from the slave nodes based on the hardware configuration of the slave nodes. In other embodiments, the slave nodes are addressable by the master node using a separate synchronization interface. In some embodiments each synchronization interface of the slave nodes is uniquely identified by the MAC and IP address.

In addition, some embodiments are directed to a file synchronization between the master node and the slave nodes is implemented using a dedicated file synchronization software. In some embodiments, the dedicated file synchronization software is Csync2. In other embodiments, the synchronization between applications running on the master node and the slave nodes is handled by the applications. In other embodiments, the synchronization between the applications is implemented using the remote procedure calls (RPC). In yet other embodiments, the system is configured using the graphical user interface application running on the master node. Still, in other embodiments, the master and the slave nodes monitor each other. In yet other embodiments, the network is distributed for firewall network processing. In other embodiments, the firewall network processing includes encryption of the network traffic. In yet other embodiments, the firewall network process includes decryption of the network traffic. And in other embodiments, the firewall network processing includes the virus scanning of the network traffic.

### BRIEF DESCRIPTION OF THE DRAWINGS

FIG. 1 illustrates an exemplary embodiment of a load balancing system according to the present invention;

FIG. 2 illustrates a flowchart of a process that can be implemented by one of the software components, according to an exemplary embodiment of the present invention that can route data packets within a cluster; and

FIG. 3 shows an exemplary network topology having a stateful clustering system that may be used to shield a private network from security threats from the Internet.

### DETAILED DESCRIPTION

Embodiments of the invention provide techniques for load balancing network traffic. The embodiments presented in this disclosure are exemplary, however, and not limiting of the invention as other implementations are possible.

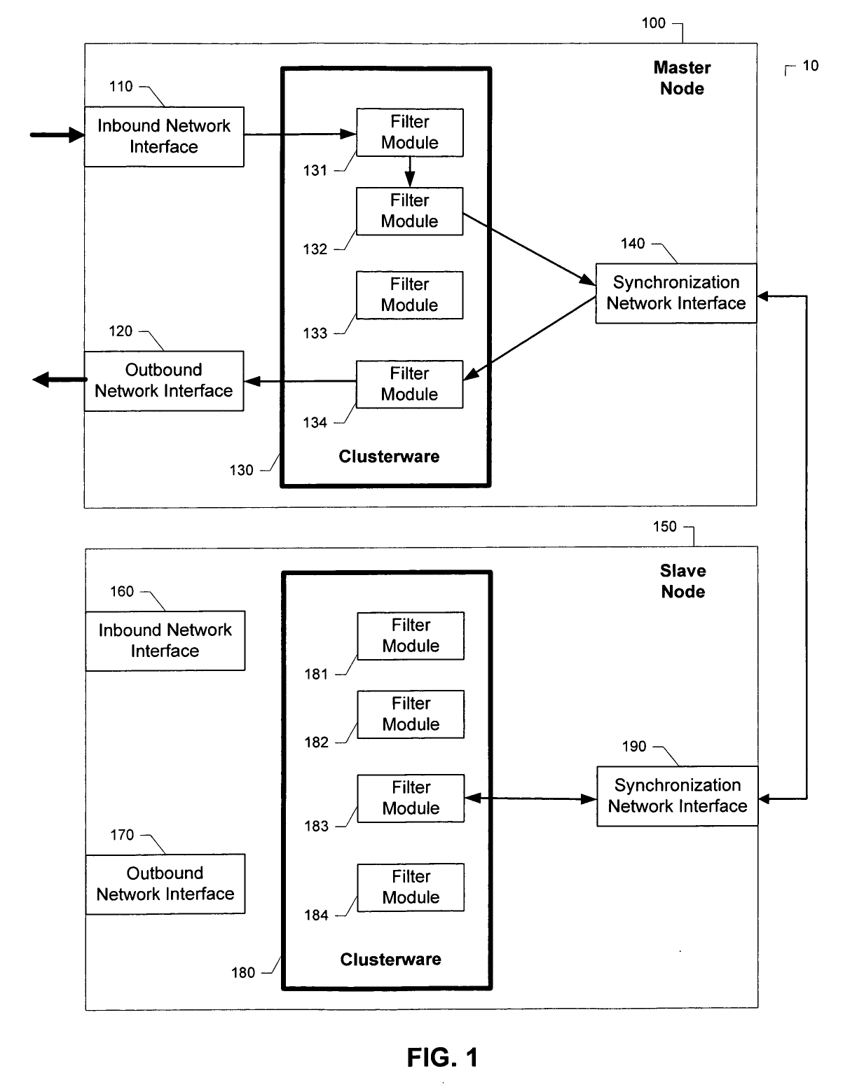

Referring to FIG. 1, a clustering system 10 according to the present invention includes a master node server 100 and a slave node server 150 that can communicate over a network connection. The master node 100 and the slave node 150 are computing devices. Generally, each of the master node 100 and the slave node 150 can include a display, motherboard, CPU (microprocessor), primary storage (RAM), expansion cards, power supply, optical disc drives, secondary storage (HD), network cards and other computer components, for example. In FIG. 1, a single slave node 150 is shown for illustrative purposes. However, the cluster 10 may include more than one, or many, slave nodes 150.

The master node 100 is configured to include an inbound network interface 1 10, an outbound network interface 120 and a synchronization network interface 140. In other embodiments of the present invention, the inbound network interface 110, the outbound network interface 120 and a synchronization network interface 140 can be combined into a single physical interface, carrying out all 3 functions. The network interfaces are generally configured to contain, for example, a network interface card (NIC), a driver that manages the NIC card and a network stack, sometimes referred to as a protocol stack. Each of the network interfaces 110, 120 and 140 can include additional components. The master node 100 is further configured to include a clusterware software component 130. The clusterware software 130 includes filter modules 131, 132, 133, 134. Generally, the clusterware software component 130 is a collection of instructions organized in functions, classes, modules, files, applications and dynamically linked libraries. The clusterware software component 130 can contain, for example, multiple software functions, classes, files, applications and dynamically linked libraries. Software components are sometimes referred to as modules. For example, the clusterware software component 130 interacts with the filter modules 131, 132, 133 and 134. Each filter module is also a software component that can contain a collection of instructions organized as functions, classes, modules, files, applications or dynamically linked libraries, for example.

The master node 100 is configured to be visible to external devices. In one embodiment, the external devices may access the master node 100 using the official IP address. Preferably, the master node 100 controls other nodes within the cluster. The master node 100 may take over all primary tasks, including packet handling, cluster node control and configuration of the cluster. The master node 100 can serve as a single point of control for the whole, or portions of, the cluster. Preferably, the cluster 10 has a single master node 100 active at any time.

The inbound network interface 110 is configured to provide the connection point between the master node 100 and a public or private network. Preferably, the network interface 110 has a network interface card (NIC) that physically connects to the network cable. The network interface 110 also includes a driver that manages the operation of the NIC and all communications between the NIC and the processor of the master node 100. Preferably, the interface also has the network stack that can be necessary for receiving the data sent using common network protocols. In one embodiment, the network interface 110 can be dedicated to accepting the inbound traffic. In other embodiments, the same interface can be used for the inbound, outbound and synchronization traffics.

The outbound network interface 120 is a connection point between the master node 100 and the public or private network. The outbound network interface may be dedicated to the outbound traffic. For example, the inbound traffic may have the data packets sent by other devices located on the public network. The packets arrive to the inbound network interface 110. The cluster 10, as illustrated on FIG. 1, processes the data packet (by scanning the contents of the file, encrypting, decrypting, etc.). The processed data packet can be output from the outbound network interface 120.

The synchronization network interface 140 is configured to be used for the inter-cluster data communications. For example, the synchronization network interface 140 can be used by the master node 100 to send the received data packet to the slave node 150. Similarly, the synchronization network interface 140 can be used by the master node 100 to receive the processed data packet from the slave node 150.

The clusterware 130 is a software application configured to run on the master node 100 and manage the operations of the cluster 10. The clusterware 130 decides how to process data packets received from the network. The clusterware 130 also decides what slave nodes 150 should be responsible for particular processing. In one embodiment, the clusterware 130 can be responsible for monitoring the state of other nodes within the cluster 10. For example, if one of the slave nodes 150 is no longer available, the master node 100 can notify an administrator.

The clusterware 130 can be configured to manage a collection of filter modules 131, 132, 133, 134, running on the master node 100. Each filter module 131,132, 133, 134 is configured to be responsible for processing data packets. For example, filter module 131 can decrypt the data packet, filter module 132 can scan the data packet for potentially dangerous information, filter module 133 can scan the data packet for viruses or filter module 134 can encrypt the data packet. Other functions are possible and envisioned.

The slave node 150 includes an inbound network interface 160, an outbound network interface 170 and a synchronization network interface 190. The network interfaces are generally configured to contain, for example, a network interface card (NIC), and a driver that manages this card and a network stack, sometimes referred to as a protocol stack. Each of the network interfaces 160, 170 and 190 can include additional components.

In the embodiment of the invention depicted in FIG. 1, only the master node 100 can communicate with the external network. As a result, the inbound network interface 160 and the outbound network interface 170 can be inactive. However, the inbound network interface 160 and the outbound network interface 170 can have an IP address and can become operative if the slave node 150 becomes the master node 100 of the cluster. For example, if the master node 100 fails, the slave node 150 can become the new master of the cluster. To function as a master, the slave node 150 can activate the inbound network interface 160 and the outbound network interface 170. The slave node 150 can also become a master node of the cluster in case of a software upgrade.

In the embodiment of the invention depicted in FIG. 1, the cluster nodes comprise a single master device and one or more slave nodes. Each node, preferably, has substantially the same number of interfaces and substantially the same hardware. Further, the networked cluster according to the present invention can be configured using the graphical user interface. The graphical user interface can be implemented as a software component running on the master node or on any other node within or outside of the cluster. The configuration of the cluster can be synchronized from the master to the slave nodes. For example, the cluster configuration can propagate automatically from the master node to all slave members of the cluster. In one embodiment, no extra configuration should be required for the slave members of the cluster.

The synchronization network interface 190 can be configured for inter-cluster data communications. For example, the synchronization network interface 190 can be used by the slave node 150 for receiving data packets from the master node 100. Similarly, the synchronization network interface 190 can be used by the slave node 150 to send the processed data packet to the master node 100.

The slave node 150 is configured to include a clusterware software component 180 that manages and interacts with the signal filter modules 181, 182, 183 and 184. Each filter module is also a software component that can contain a collection of instructions organized as functions, classes, modules, files, applications or dynamically linked libraries, for example.

The slave node 150 can be hidden from external devices. In some embodiments, the slave node 150 can have an assigned IP address that can remain inactive. The slave node 150 does not have to provide ARP responses and can drop any directly received external packets.

Generally, the slave node 150 is used by the master node 100 for the CPU-intensive processing. In one embodiment, the master node 100 can use slave nodes 150 for firewall engine processing of the network packets. For example, the slave node 150 can be used for content scanning proxies for HTTP, SMTP and POP3 protocols. The slave node 150 can also be used for encryption and decryption of IPSec traffic. The slave nodes can also be used for the Snort Intrusion Protection.

The clusterware 180 is configured to run on the slave node 150 and perform instructions of the clusterware 130, running on the master node 100. For example, a clusterware 180 may receive a data packet and the packet state information from the master node 100 with the instruction to scan the data packet for viruses. The clusterware 180 is configured to redirect the data packet to the virus scanning filter module, instruct the filter module to process the packet and send the processed packet together with the packet state information back to the master node 100.

The clusterware 180 is further configured for managing a collection of filter modules 181,182, 183, 184 running on the slave node 150. Each filter module 181, 182, 183, 184 can be responsible for processing data packets. For example, filter module 181 can decrypt the data packet, filter module 182 can scan the data packet for potentially dangerous information, filter module 183 can scan the data packet for viruses or filter module 184 can encrypt the data packet. Other functions are possible and envisioned.

With continued reference to FIG. 1, the cluster 10 is configured to be used for stateful firewall clustering. Stateful firewall clustering is configured to provide the benefits of using multiple servers for firewall processing of network traffic. Stateful firewall clustering also supports the high-availability of network applications. Network packets can be preserved even if one of the servers within the cluster fails. The cluster 10 is configured to balance network traffic between servers without the help of a load balancer. Specifically, the cluster 10 can balance network traffic after the network traffic arrives on a network stack of the inbound network interface 110. The cluster 10 can support the stateful clustering because the clusterware applications 130 and 180 monitor and share the state of the data packets.

Network traffic is analyzed by the master node 100 and forwarded to the slave node 150 for processing various CPU-intensive tasks. For example, CPU-intensive tasks can include virus scanning, intrusion detection and IPSec decryption. The tasks can also include the Content Filter services for HTTP, POP3, SMTP, IMAP and FTP protocols, for example. In one embodiment, the filter modules can operate on various hardware based cluster nodes. The external devices that interact with the cluster 10 may not even know that the cluster 10 contains two network servers. Instead, the entire cluster 10 can be configured to operate as a single machine with a single network IP address.

In one embodiment, the clusterware 130 can detect the failure of one or more slave nodes within the cluster. In that embodiment, the master node can redistribute the packets among the functioning nodes within the cluster. Thus, the cluster service can appear to operate without interruptions.

The clusterware 130 can also maintain the packet distribution information. This information tracks what packets are routed to what nodes. This information can be useful if the packets need to be re-routed. In some embodiments, the distribution information can be maintained by one or more slave nodes of the cluster.

The external devices do not need to know anything about the internal configuration of the cluster 10. Instead, to communicate with the cluster 10, the external applications use the official IP address assigned to the master node 100. As a result, the processing of the packet after it arrives to the master node 100 is substantially hidden from the external applications. For example, the cluster 10 balances the network traffic between servers without the help of a load balancer. Instead, the balancing decision is done by a network server, referred to as a master node 100. Preferably, the cluster 10 has one master node that is responsible for balancing network traffic.

As illustrated in FIG. 1, the data packet arrives at the inbound network interface 110, of the master node 100. In one embodiment, the network interface 110 receives the data packets from the network using the official IP address. Preferably, the network interface 110 is implemented using the network card (NIC), network card drive and the network stack.

The flow of the data packet is controlled by the master node clusterware 130. For example, the clusterware 130 may decide that the packet needs to be processed by the filter module 131, filter module 132, filter module 133 and filter module 134. The filter modules may perform various tasks, such as analyzing the contents of the data packet, decrypting or encrypting the data, etc. The clusterware 130 routes the packet to the filter module 131 and filter module 132, wherein both of these modules are running on the master node 100.

Based on the preconfigured set of conditions, the clusterware 130 chooses to process the data packet using the filter module 183, running on the slave node 150. The preconfigured set of conditions can operate as a function of the active servers within the cluster. The conditions can also operate based on the specific software algorithm, such as “round robin.” In some embodiments, the conditions can operate as a function of the resource utilization on the active nodes within the cluster. For example, if the first slave node has 30% CPU utilization and the second slave node has 50% CPU utilizations the clusterware 130 can choose the first slave node because it has the smallest CPU utilization.

As illustrated in FIG. 1, the clusterware 130 can forward the data packet and the filter state information necessary to process the packet to the slave node 150 using the synchronization interface 140.The clusterware 180 running on the slave node 150 detects an incoming data packet and the filter state information on the synchronization interface 190. In one embodiment, when the slave node 150 receives the data packet and its filter state from the master node 100, the slave node 150 positions the data packet in the exact same position of the filtering process. As a result, the individual filter modules of the slave node are not aware of whether the data packet being processed came in from the external network or from another node within the cluster 10.

The clusterware 180 invokes the filter module 183 to process the data packet on the slave node 150. The filter module 183 processes the data packet. The clusterware 180 running on the slave node 150 sends the data packet back to the master node 100 using the synchronization interface 190. The clusterware 130, running on the master node 100 receives the data packet sent by the slave node 150. The clusterware 130 routes the packet to the filter module 134 and to the outbound network interface 120.

Each node within the cluster can have a synchronization interface with separate IP and MAC addresses that uniquely identify each node. In one embodiment, all outbound and inbound network interfaces share the same IP address, but have separate MAC addresses. As a result, the cluster 10 can appear as a single machine.

The clusterware applications 130 and 180 can be implemented using several software components. Importantly, the exact number of software components is not limiting for the purposes of the present invention and is used solely to illustrate a possible implementation of the present invention.

Although the clusterware 130 running on the master node 100 and the slave node 150 can be substantially identical, they, nonetheless, can operate in different modes. For example, the clusterware 130 running on the master node 100 can handle the master tasks such as communicating with external devices, delegating network packet processing to other nodes, monitoring and maintaining the list of active nodes within the cluster. Further, the clusterware 130 running on the master node 100 is responsible for administering the cluster distribution. It can choose what cluster node should be selected for processing a particular filter or task. This selection can be based on the resource availability on the master node 100. This selection can also be based on a software algorithm or a cpu usage of slave nodes, as explained hereinabove.

As shown in FIG. 1, the clusterware 130 may decide that the network packet needs to be processed by the filter module 131, filter module 132, filter module 133 and/or filter module 134. The filter modules 131, 132, 133, 134 may perform various tasks, such as analyzing the contents of the data packet, decrypting or encrypting the data. Based on a preconfigured set of factors, the clusterware 130 may decided that the filters 131, 132 and 134 should be processed on the master node 100, but filter 133 (or, its equivalent, filter 183) should be processed by the slave node 150.

To delegate the processing of the filter 133 to the slave node 150, the clusterware 130 running on the master node 100 and the clusterware running on the slave node 150 is synchronized using the synchronization interfaces 140 and 190. The clusterware 130 can synchronize the data between the filters running on different nodes, without the need to specifically alter the filter applications. For example, the application synchronization can be implemented using an open source file synchronization tool, such as csync2. Csync2 is designed to synchronize files located on different computers. In some embodiments, csync2 can synchronize the quarantined objects of a content scanner. Csync2 can synchronize licensing information, such as license code and IP track list. It can also synchronize the software updates, virus patters and IDS signatures. Similarly, it can synchronize the remote administration certificates, such as WebAdmin and ssh public key.

Alternatively, network applications can be synchronized using the application-specific status updates. For example, cluster and high availability (HA-aware) applications can synchronize their internal state using their own protocols. HA-aware applications are designed to communicate with each other over the network to exchange the packet state information. In some embodiments, HA-aware applications can also synchronize the encryption key or alterable setting information. In some embodiments, the amount of the synchronization traffic can be minimized by scheduling the synchronization tasks. For example, the cluster administrator can configure the HA-aware applications running on the cluster to synchronize every 15 minutes.

In one example, the application specific synchronization can be used to synchronize established IPSec tunnels (Security Associations) and their encryption keys. The application specific synchronization can synchronizes IPSec sequence numbers, which can be synchronized in ranges instead of after each packet. Further, IPSec tunnel synchronization can enhance the existing IPSec-based VPN solutions, such as “Strongswan.”

The application specific synchronization can also be used to synchronize the database files. For example, the application specific synchronization can be used to synchronize the files of the MySQL database. In another embodiment, the applications running on different nodes within the cluster can be synchronized using the remote procedure calls (RPC). RPC allow a function running on one server to invoke another function, running on another server. For example, one type of the remote procedure calls, commonly referred to as PerlRPC, can be used to synchronize the internal configuration of the system via a web graphical user interface.

The cluster 10 can be configured to share the state of the data packet between multiple servers within the cluster. This information can be used to avoid the loss of the data packet in case of a server failure. In one embodiment, each node in the cluster 10 has substantially the same number of interfaces. A unique MAC address can be assigned to each interface. To ensure a faster takeover and to force an update of the ARP tables of the attached hosts, the master node 100 (or the newly elected master node) can send ARP messages containing the external IP addresses to the active slave nodes within the cluster.

The clusterware 130 running on the master node 100 is configured to be responsible for monitoring and maintaining the list of the active nodes within the cluster. In one embodiment, the clusterware running on the master node sends messages on the cluster synchronization interface requiring all recipients to respond. The information about responding slave nodes 150 can be stored in the random access memory (RAM) of the master node 100. If the master node 100 is restarted, the data stored in the RAM can be lost. The list of the active nodes can be kept in RAM, recorded in the database or written to a file. If the master node 100 fails and needs to be restarted, the list of the active nodes can be retrieved from the database and verified. In one embodiment of the invention, each node keeps track of the full topology of the cluster.

In case of a cluster node failure, the master node 100 is configured to notify the administrator by sending an email message to the pre-configured email address. The master node 100 could also notify the administrator by making an automated phone call with a recorded message to the preconfigured phone number. For example, the clusterware 130 running on the master node 100 can detect that not all of the slave nodes 150 recorded in the list of the active nodes responded to the master's communication request. The clusterware 130 running on the master node 100 can compose an email message by emailing a pre-configured message template together with the list of failed nodes to the cluster administrator.

In one embodiment, each node can have a pre-assigned range of network ports. For example, the table below shows one possible configuration:

| Node | Start | End |
|---|---|---|
| 1 | 24576 | 28671 |
| 2 | 28672 | 32767 |
| 3 | 32768 | 36863 |
| 4 | 36864 | 40959 |
| 5 | 40960 | 45055 |
| 6 | 45056 | 49151 |
| 7 | 49152 | 53247 |
| 8 | 53248 | 57343 |
| 9 | 57344 | 61439 |
| 10 | 61440 | 65535 |

The port map above can ensure that all nodes have their own port range and therefore full TCP/IP and UDP/IP network access. The master nodes distributes packets according to these list to other nodes. In one example, the networked cluster according to the present invention, does not require the Network Address Translation (NAT) to be performed at the time when the network packet is received. In one embodiment this can be implemented by performing the address translation prior to transferring the data packet to a different cluster node.

In one embodiment, the present invention does not require the connection tracking table to be replicated to all cluster nodes. Instead, the connection tracking table can be maintained on one slave node. This reduces the amount of data to be synchronized. The complexity of the cluster system can be decreased. In other embodiments of the present invention, the connection tracking entries can be synchronized.

In another embodiment, the master node of the networked cluster can be dynamically reassigned. For example, if the master node fails, the slave nodes can vote for the new master to take over all control of the cluster. In one embodiment, the master node can be selected randomly. In other embodiments, the master can be selected based on the hardware characteristics of the particular slave nodes. The master can also be selected based on the node id. For example, the master selection algorithm can elect a new master by promoting the slave node with the highest node id.

In one embodiment of the present invention, the master and slave nodes can automatically recognize each other. For example, if a new slave node is connected to the networked cluster, the slave node will automatically register with the master node by sending a configuration request to the current master. The master node can reply with all necessary configuration options and an unused node id.

In one embodiment, the cluster according to the present invention can run on blade systems and Astaro Security Gateway (“ASG”) appliances. Astaro Security Gateways are hardware devices designed for complete protection of the computer networks from the network security threats. In one embodiment, the cluster status and messages can be displayed on the LCD displays of the ASGs.

In one embodiment the clusterware 130 can be implemented as a collection of software components. Distributing the functionality of the clusterware among multiple components can provide a more stable software environment. For example, one software component can be responsible for keeping track of the active nodes and assigning new connections to the slave nodes using a distribution algorithm, as discussed hereinabove.

Another software component can be responsible for saving the packet state information before the packet leaves or after the packet arrives to a particular node. This function is important because each distributed packet can contain preserved packet state information and preserved filter module information. Another software component can be responsible for insuring that data packets are properly being routed within the cluster. For example, if the master node establishes a connection and later sends a data packet to one of the slave nodes for specific filter processing, this software module can ensure that the data packet is delivered to the appropriate slave and sent back to the master.

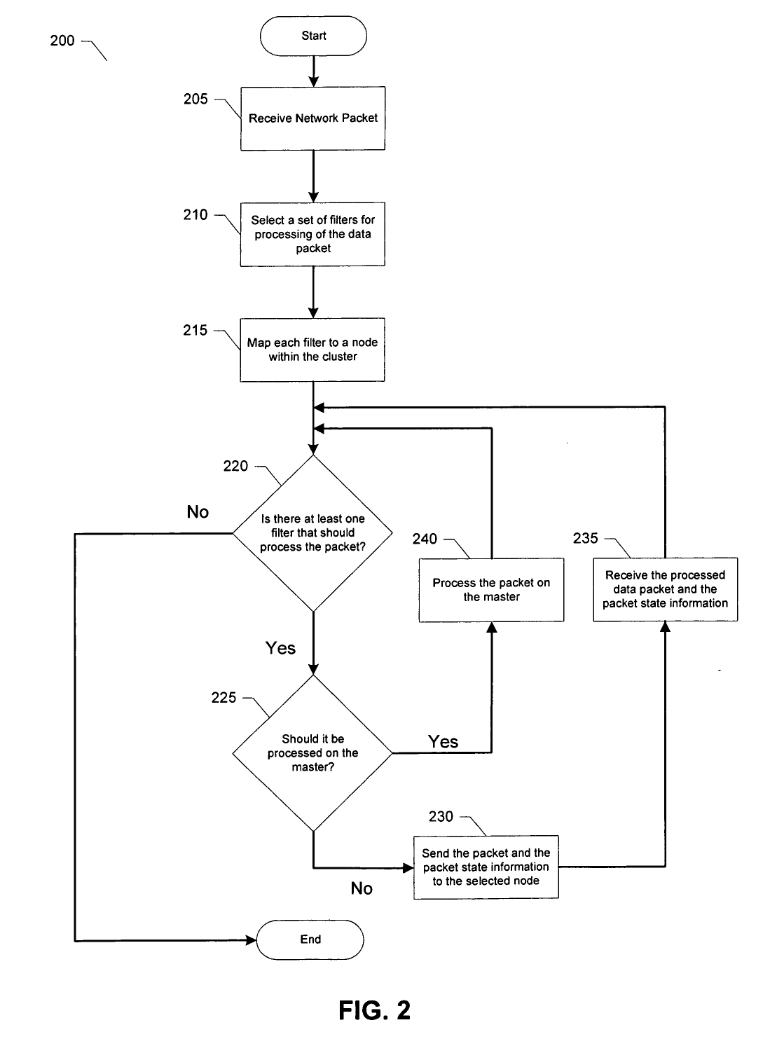

FIG. 2 illustrates a flowchart diagram 200 that can be implemented by one of the software components, according to the present invention. This component can be responsible for routing data packets within the cluster. The flow chart 200 illustrates step 205, in which the component receives the data packet from the external device. In step 210, the component selects a set of filters for processing of the data packet. This set of filters can include various firewall processing, such as decryption, encryption and virus scanning.

In step 215, the component can map each filter to a specific node within the cluster. The flow chart 200 executes this step only once and before processing the data packet by any of the filters. In some embodiments, however, this step can be implemented immediately before the packet is processed by each filter. In that scenario the cluster will always choose the optimal node for processing a particular filter. The downside of it is frequent checks for resource utilizations of cluster nodes can decrease the overall performance of the cluster.

In step 220, the component makes sure that there is at least one filter that should process the data packet. If the packet does not need to be processed by any filter, the software component may finish the processing of the data packet. When the filter processing of the data packet is complete, the software component can pass control of the packets to other software components.

If the packet still needs to be processed by one or more filters, step 225 can be performed to decide whether the packet needs to be processed on the master node or on a slave node of the cluster. As explained hereinabove, the decision can be as simple as consulting the filter-node map generated in the step 215. Alternatively, the decision can involve monitoring the resource utilization of the available nodes of the cluster. If the packet should be processed on the master node, in step 240 the packet is forwarded to the filter running on the master node and then a check 220 for more filter processing can be performed.

Conversely, if the packet should be processed by a slave node, in step 230 the packet and the packet state information is forwarded to the selected slave node. As illustrated in the flowchart 200, the filter processing can be synchronous, in a way that each data packet is processed by only one filter at any point in time. In other embodiments, however, the filter processing can be asynchronous. In these embodiments the master node, after forwarding the data packet to one of the slave nodes, does not need to wait for the processed packet to return. Instead, the master node can perform other processing of the data packet. When all packets are processed either by the master node or by slave nodes of the cluster, the control of the data packet can be passed to another software component.

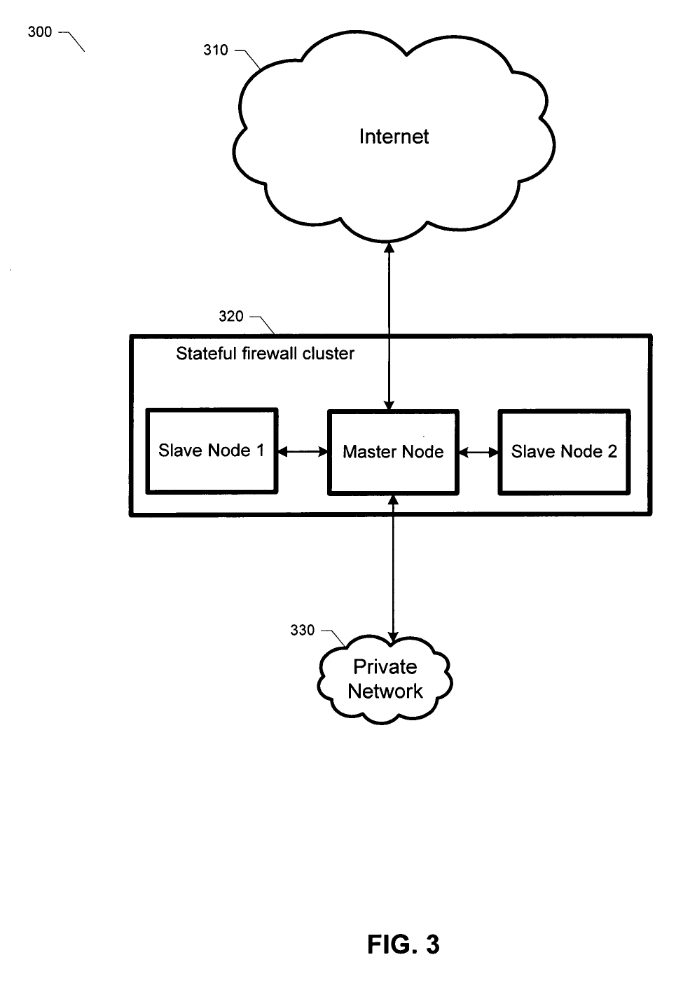

FIG. 3 shows a network topology 300 illustrating one possible implementation of the stateful clustering system. In that topology the stateful clustering system 320 is used to shield the private network 330 from the security threats coming from the Internet network 310. The data flowing from the Internet 310 first arrives to a master node of the clustering system 320. Clustering system 320 distributes the stateful firewall processing between itself and the available slave nodes within the cluster. After the incoming data is processed, the processed data is forwarded to the private network 330.

The embodiment of the present invention described with respect to FIG. 1,2 and 3 is exemplary only and not limiting. This embodiment may be altered, e.g., by having stages or components added, removed, or rearranged. Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations. Further, while the description above refers to the invention, the description may include more than one invention.

What is claimed is:

1. A method for balancing network traffic comprising:
receiving data packets at a master node;
applying a set of conditions to determine one or more slave nodes for processing the data packets;
forwarding the data packets and a filter state information to the determined slave nodes for processing;
receiving the processed data packets and the filter state information from the slave nodes; and
outputting the data packets from the master node.

2. A system for balancing network traffic comprising:
a master node addressable by an external device;
at least one slave node addressable by the master node;
at least one filter running on the master node and the at least one slave node;
a clusterware application running on the master node and the at least one slave node,
wherein the clusterware application is configured to distribute the network traffic between the master node and the at least one slave node.

3. The system of claim 2, wherein the clusterware application running on the master node monitors and maintains a list of slave nodes.

4. The system of claim 3, wherein the list of slave nodes is maintained in RAM.

5. The system of claim 4, wherein the list of slave nodes is saved on the disk storage.

6. The system of claim 5, wherein the list of slave nodes is saved in the database file.

7. The system of claim 2, wherein, in case of the master node's failure, the clusterware application running on the slave nodes selects a new master.

8. The system of claim 7, wherein the new master is selected from the slave nodes based on the hardware configuration of the slave nodes.

9. The system of claim 2, wherein the slave nodes are addressable by the master node using a separate synchronization interface.

10. The system of claim 9, wherein each synchronization interface of the slave nodes is uniquely identified by the MAC and IP address.

11. The system of claim 2 wherein the file synchronization between the master node and the slave nodes is implemented using a dedicated file synchronization software.

12. The system of claim 11, wherein the dedicated file synchronization software is Csync2.

13. The system of claim 2, wherein the synchronization between applications running on the master node and the slave nodes is handled by the applications.

14. The system of claim 2, wherein the synchronization between the applications is implemented using the remote procedure calls (RPC).

15. The system of claim 2, wherein the system is configured using the graphical user interface application running on the master node.

16. The system of claim 2, wherein the master and the slave nodes monitor each other.

17. The system of claim 2, wherein the network is distributed for firewall network processing.

18. The system of claim 17, wherein the firewall network processing includes encryption of the network traffic.

19. The system of claim 18, wherein the firewall network process includes decryption of the network traffic.

20. The system of claim 18, wherein the firewall network processing includes the virus scanning of the network traffic.
